(19) United States
(12) Patent Application Publication
(10) Pub. No.: US 2011/0213978 A1
(43) Pub. Date: Sep. 1, 2011

(54) SECURE METHODS OF TRANSMITTING AND RECEIVING DATA BETWEEN TERMINALS COMPRISING NEAR-FIELD COMMUNICATION, AND CORRESPONDING TERMINALS

(75) Inventor: Eric Fouchard, Bruz (FR)

(73) Assignee: SAS TAZTAG, Bruz (FR)

(21) Appl. No.: 13/061,400

(22) PCT Filed: Aug. 28, 2009
(86) PCT No.: PCT/EP09/61176

§ 371 Date: May 17, 2011

(30) Foreign Application Priority Data
Aug. 28, 2008 (FR) 08/04751

(51) Int. Cl. H04L 9/32

(52) U.S. Cl. 713/171

(57) ABSTRACT

A method is provided for secure transmission of a data file from a sender terminal to at least one recipient terminal, each including a near-field communication device and implementing an encryption of the file, as a function of at least one item of encryption information that is known or determined by the sender terminal. The includes the following steps, in the sender terminal: dividing the file into a first file portion and a second file portion; sending with the near-field communication device a first data set including at least one portion of the encryption information item and the first file portion to the recipient terminal or terminals; sending with a radiofrequency transmitter a second data set including at least the second file portion to the recipient terminal or terminals.

### CROSS-REFERENCE TO RELATED APPLICATIONS

This Application is a Section 371 National Stage Application of International Application No. PCT/EP2009/061176, filed Aug. 28, 2009 and published as WO 2010/023298 on Mar. 4, 2010, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of contactless data exchanges between mobile devices, with embedded near-field communication (or NFC).

More specifically, the relates to the improvement of such exchanges, in particular with regard to securement and confidentiality.

### BACKGROUND OF THE DISCLOSURE

Near-field communication devices are based on technology for data exchange at a distance of several centimeters, with the following main features:
maximum communication rate: 424 kbit/s;
frequency range: 13.56 MHz;
communication distance: maximum 10 cm;
communication mode: half-duplex or full-duplex.

This technology, which is promoted by the “Forum NFC” consortium, can be applied in various uses, such as data exchanges with a contactless smart card (or a terminal emulating such a smart card, for example a mobile telephone), the reading of passive tags (electronic labels), or the exchange of data between terminals, for example electronic visit cards (“vCard”), photos, videos, and so on.

One of the advantages of the NFC technique is that it is non-intrusive. Because it can be implemented only over very short distances (fewer than 10 centimeters), it assumes a voluntary approach by the user, or users, and cannot therefore, in principle, be used without their knowledge.

This advantage is, however, also a disadvantage. Indeed, in many situations, it is impractical to keep two terminals near one another for a relatively long time (several seconds or tens of seconds once the data to be sent reaches a certain volume, and, for example, if it comprises photos or videos). Indeed, the communication rate of the technique is slow (maximum of 424 kbit/s).

It is understood, for example, that an exchange of “vCards” (comprising photos) between two people, in a trade show, cannot require the people to stay close for several seconds (several centimeters from one another). Not only is the transmission time too long, but it also risks being interrupted by an ill-timed movement, resulting in a data transfer failure.

In addition, a user can receive a large amount of unwanted or unneeded data. Also in the example of a trade show, the memory of the terminal will quickly be overloaded, if all of the visit cards with images or video of people met are stored without discretion. The user will therefore have to regularly check and erase items in order to free up memory space.

Another disadvantage is, at least in some cases, the lack of confidentiality of the data sent, and the lack of a guarantee of the uniqueness of the transmission. Even if it is not significantly problematic in the case of a visit card exchange, it may be crucial in other applications, such as ticketing, for example for an event or couponing, and more generally for any confidential and/or personal information.

### SUMMARY

An aspect of the disclosure relates to a method for secure transmission of a data file from a sender terminal to a recipient terminal, each comprising near-field communication means and implementing an encryption of said file, according to at least one encryption information item known and determined by said sender terminal.

According to an embodiment of the invention, this method comprises in particular the following steps in said sender terminal:
dividing of said file into a first file portion and a second file portion;
transmission, by means of said near-field communication means, of a first data set comprising at least some of said encryption information and said first file portion to said recipient terminal(s);
transmission, by means of radiofrequency transmission means, of a second data set comprising at least said second file portion, to said recipient terminal(s).

Thus, according to an embodiment of the invention, confidentiality is ensured not only by the implementation of encryption, but also by the fact that the encrypted file is distributed, and sent in two separate parts, or portions, by two separate transmission means. The transmission of information between the two terminals is very secure, and very difficult to hack.

The use of a radiofrequency connection for the second file portion (which can, with regard to the amount of data, be larger than the first) enables an exchange at a faster rate and/or at a greater distance. The exchange is initiated by NFC, which assumes a voluntary action of bringing the two terminals within 10 cm of one another.

Then, once the first file portion has been sent, which occurs for example in less than one second, each user can place his or her terminal in a pocket, and move away (a radiofrequency connection enables, according to the circumstances, transmission over several dozen or hundred meters).

This radiofrequency transmission can of course be detected by a malevolent or at the very least unauthorized third party. However, said third party will receive only encrypted data, which therefore cannot be used. Even if said third party knows, or manages to identify the encryption key(s) by tests, he or she will be able to decode only a portion of the file sent, and will not therefore be able to restore the complete file, since he or she will not have the first portion of the file sent by NFC.

According to a particular embodiment, it is possible to require, in the NFC exchange phase, the two terminals to be even closer to one another than the standard, for example, at a distance of between 0 and 4 cm (for example, by means of an ad hoc antenna).

This makes it possible to improve confidentiality, because it is difficult for a third party to place a “pirate” terminal fewer than 4 cm away in order to listen and recover the data exchanged (which comprises keys, in particular), and to reduce the electrical consumption necessary for the transmission and receiving of data.

In addition, according to an exemplary embodiment, the method also comprises the following steps:
receiving of a first encryption key portion sent by said recipient terminal;
construction of an encryption key, according to said first encryption key portion and a second encryption key portion, provided by said sender terminal;
encryption of said data file by the sender terminal, by means of said encryption key, delivering an encrypted file.

Advantageously, said first encryption key portion and/or said second encryption key portion are key portions for a single use, generated in a pseudo-random manner by the respective terminals.

The data exchange is then performed by means of an encryption key for single use, and it is not possible to pirate or re-send this data. This makes it possible in particular to implement, in a simple and secure manner, ticketing or couponing applications and so on, using the terminals of an embodiment of the invention.

The dividing step can be performed before or after the encryption. If the division is performed before the encryption, the two file portions resulting from the division can be encrypted independently. It is also possible, according to the particular case, to encrypt only one of the two file portions.

According to an embodiment, the dividing step implements a step of evaluating the size of said data file with respect to a predetermined parameter. Thus, according to this evaluation and the comparison of the size of the file with a predetermined parameter, for example if the file size exceeds 100 Ko, the step of dividing of said file into a first file portion and a second file portion is implemented if the file is larger than the predetermined parameter.

On the contrary, when the data to be sent is of small size (for example a ticket or a coupon), all of it can be sent integrally by near-field communication means (for example, via network exchanges with a NFC/IP gateway in a ticketing solution).

In addition, said first and second file portions can in particular correspond, respectively, to a header or a header portion, and at least one content portion of said file.

The header can include various data necessary for the interpretation and/or processing of the content. Thus, without the header, it is not possible to recover the file contents (even if the file has been successfully decrypted).

According to an advantageous embodiment of the invention, said first data set also comprises data for identification of said sender terminal, in particular the ZigBee address, for example, and/or the holder thereof.

This identification data can in particular enable the user receiving it to accept or reject the next part of the transmission.

In this case, a step of receiving acceptance information by at least one of said recipient terminal(s) can be provided, so that the radiofrequency channel provides no transmission if no acceptance information is received.

In a particular embodiment of the invention, said radiofrequency transmission means implement a ZigBee® protocol.

Numerous other protocols can of course be used, in particular according to the desired transmission rates and/or distances.

According to a particular embodiment of the invention, said encryption step also takes into account a second key, sent by the recipient terminal by means of said near-field communication means.

The key portions can be exchanged in an encrypted manner, with a master key stored in a secure module of each terminal.

An embodiment of the invention also relates to a method for secure receiving, in a recipient terminal, of a data file sent by a sender terminal according to the transmission method described above.

Such a receiving method comprises in particular the following steps:
receiving, by means of near-field communication means, a first data set comprising at least some encryption information and at least one first file portion;
receiving a second file portion, by radiofrequency communication means;
restoring a file received, by combining said first and second file portions;
decrypting said file received.

According to an advantageous embodiment, this receiving method also comprises the following steps:
sending a first encryption key portion to said sender terminal, so as to enable the latter to construct an encryption key, by producing a second encryption key portion;
creating an encryption key, according to said first encryption key portion and a second encryption key portion, extracted from said first file portion.

The step of restoring a file received can be performed before or after the decryption. If this step is performed after the decryption, the two file portions can be decrypted independently. It is also possible, as the case may be, to decrypt only one of the two file portions.

Advantageously, as said first data set also comprises data for identification of said sender terminal and/or the holder thereof, the receiving method also comprises a step of accepting the transmission according to said identification data, resulting in the transmission of acceptance information, authorizing the transmission of said second data set.

In numerous applications, the terminals comprise means for implementing the transmission method and the receiving method, and can perform the two operations simultaneously, as the case may be. In some applications, however, it is possible for the particular terminals to implement only the transmission method, or only the receiving method.

An embodiment of the invention thus relates to terminals enabling the secure transmission of a data file to at least one recipient terminal, according to the transmission method described above. Such a terminal comprises in particular near-field communication means and means for encrypting said file, according to at least one encryption information item known or determined by said sender terminal, as well as:
means for dividing said file into a first file portion and a second file portion;
means for near-field transmission of a first data set comprising at least some of said encryption information and said first file portion to said recipient terminal(s);
means for radiofrequency transmission of a second data set comprising at least said second file portion to said recipient terminal(s).

An embodiment of the invention also relates to terminals enabling the secure receiving of a data file intended for at least one recipient terminal, according to the receiving method described above. Such a terminal comprises in particular near-field communication means, as well as:
means for receiving, implementing said near-field communication means, a first data set comprising at least some encryption information and at least a first file portion;
means for receiving a second file portion, implementing radiofrequency communication means;
means for restoring a file received, by combining said first and second file portions;
means for decrypting said file received according to at least one encryption information item known or determined by said sender terminal.

Such a terminal can, in a particular embodiment, be in the form of a portable card equipped with a screen, enabling in particular the display of identification data of another terminal and/or the user thereof.

An embodiment of the invention also relates to computer programs that can be downloaded from a communication network and/or stored on a computer-readable medium and/or run by a microprocessor, characterized in that it comprises program code instructions for performing the steps of the transmission method and/or the receiving method as described above, when this method is performed on a computer.

### BRIEF DESCRIPTION OF THE DRAWINGS

Other features and advantages will become clearer in view of the following description of an embodiment of the invention, provided as a simple illustrative and non-limiting example, and the appended drawings, in which:

FIG. 1 diagrammatically shows an example of a system implementing an embodiment of the invention;

FIG. 2 shows the essential means of a card of the system of FIG. 1 according to an illustrative embodiment;

FIG. 3 is a simplified diagram of the transmission method implemented by the terminal of FIG. 2;

FIG. 4 is a simplified diagram of the receiving method implemented by the terminal of FIG. 2.

### DETAILED DESCRIPTION OF ILLUSTRATIVE EMBODIMENTS

An embodiment of the invention relates to an improvement in NFC data exchange techniques making it possible to send, quickly and without proximity constraints, data corresponding to a relatively large file (capable of containing documents, photos or videos, for example), while ensuring a high level of confidentiality.

This confidentiality is ensured by the implementation of encryption and by a division of the encrypted file into two file portions. Thus, the first portion can be sent, classically, by an NFC connection, like the information necessary for the decryption, and the second portion can be sent by complementary radiofrequency transmitter, enabling the transmission to be completed at a higher rate, and/or without proximity constraints (several dozen meters), between the terminals concerned.

An embodiment of the invention is applicable to numerous fields requiring both confidentiality and relatively high speed. It can, for example, involve downloading of files (audio files, video files, etc.) from a terminal provided for that purpose, the downloading of advertising or news information or the exchange of electronic visit cards (“vCards”) capable of having, as the case may be, one or more photographs or videos, as well as documents, for example a company presentation or catalogue. It can also involve various private, personal and/or confidential documents.

An embodiment of the invention can also be implemented in numerous types of terminals, and for example in radiotelephony terminals, for which NFC communication devices are often used, for example, for contactless payment applications.

It can also be implemented in dedicated terminals, for example in the form of a flat, low-profile element, for example in the form of a credit card. The embodiment described below, in terms of an example embodiment, concerns such cards.

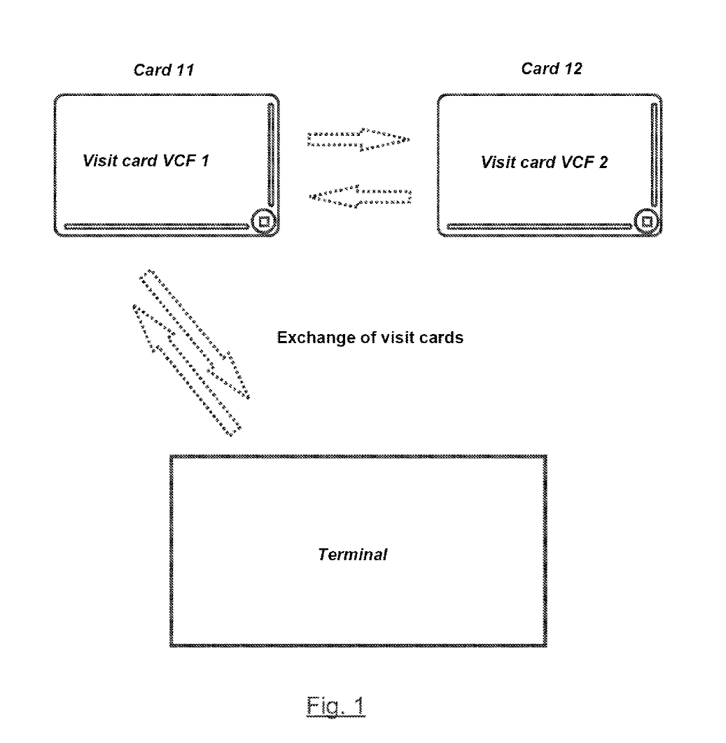

Thus, as shown in FIG. 1, two cards 11 and 12, which can in particular be equipped with a screen 111, 121 for showing information, and a keypad 112, 122 (and more generally any other useful interface, communication and securement means, such as a biometric sensor), can exchange data according to the approach of an embodiment of the invention.

For this, each of the cards 11 and 12 comprises NFC communication devices 113, 123 and radiofrequency communication devices 114, 124.

Thus, in the example of a visit card exchange, the two users bring their respective cards 11 and 12 together, to within 10 cm of one another. The user of card 11 activates a visit card transfer, for example by the keypad 112 (according to an alternative, this transfer can begin automatically, when a card is detected in the vicinity), and the NFC communication devices 113 send, to the corresponding means 123 of card 12, a first file portion, obtained according to the method described below. After verification, for example by reading on the screen 121, the user of card 12 accepts the next transfer portion.

A second file portion is then sent, by way of radiofrequency communication device 114, by implementing, for example, the ZigBee® technique, which enables transmissions over several dozen meters. This second file portion is received by the card 12, via his radiofrequency receiving device 124. For this second transmission by radiofrequency, it is not necessary for the two cards 11 and 12 to remain close to one another.

It is of course possible for the two cards 11 and 12 to exchange their visit card information, and therefore each ensures the transmission and receiving of data.

As the data sent is encrypted, according to an embodiment of the invention, each of the cards also comprises encryption and decryption, and exchanges the necessary encryption keys or key portions, by NFC communication.

As shown in FIG. 1, the exchange can also be performed between a card 12 and a terminal of another type, for example a terminal 13, capable of providing, upon entry into a city, a map of said city or tourist information, on a trade stand, information to be presented by the company concerned, on a billboard, information on the advertisement, and so on.

The terminal 13 comprises, like terminal 11, display 131, interface (keypad or touchpad) 132, NFC communication device 133 and radiofrequency communication device 134, capable of communicating with the corresponding devices 123 and 124 of the card 12.

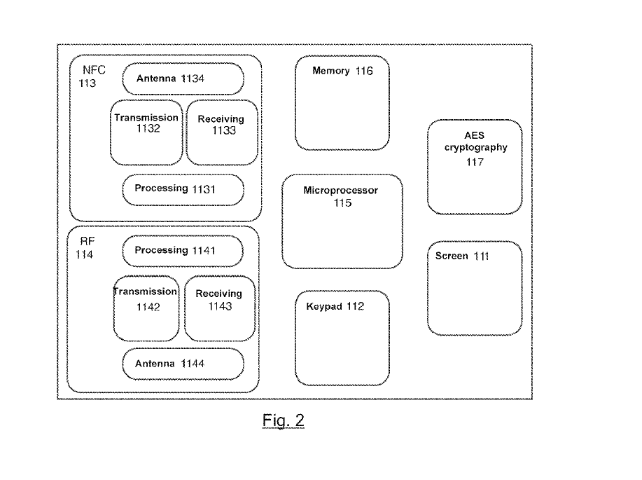

FIG. 2 diagrammatically describes the technical elements of a card 11 or 12 in a specific embodiment.

This card therefore comprises an antenna according to NFC standards 113 communicating with NFC signal processor 1131, comprising NFC receiver 1133 and NFC transmitter 1132. These elements, known and described in the literature, are not detailed here.

Similarly, the radiofrequency communication device, which can in particular be applied to the ZigBee® standard, as specified above, which makes it possible to ensure data exchanges at a sufficient rate, over distances of several dozen meters, will not be described in detail. It is thus possible to send visit cards with photographs in several seconds, without requiring the users to keep their cards in (quasi-)contact. These means therefore include an antenna 1144 and corresponding signal processor 1141, ensuring RF receiving 1143 and RF transmission 1142.

The processors 1131 and 1141 ensure demodulation and forming of signals, according to the chosen coding techniques, and exchange digital signals with a microprocessor 115. The microprocessor 115 performs the classic functions of a card, more generally a terminal, encrypted with encryption means 117 and sends in particular the information to a screen 111. It can receive keypad commands 112, and more generally comprises any useful human/machine interface means.

This microprocessor 115 is connected to a memory 116, storing its operating program and data downloaded or exchanged according to the technique of an embodiment of the invention. The microprocessor 115 is therefore also capable of implementing the transmission and receiving methods of an embodiment of the invention, as described below (in some specific cases, a terminal may include only means for implementing the transmission method or the receiving method only).

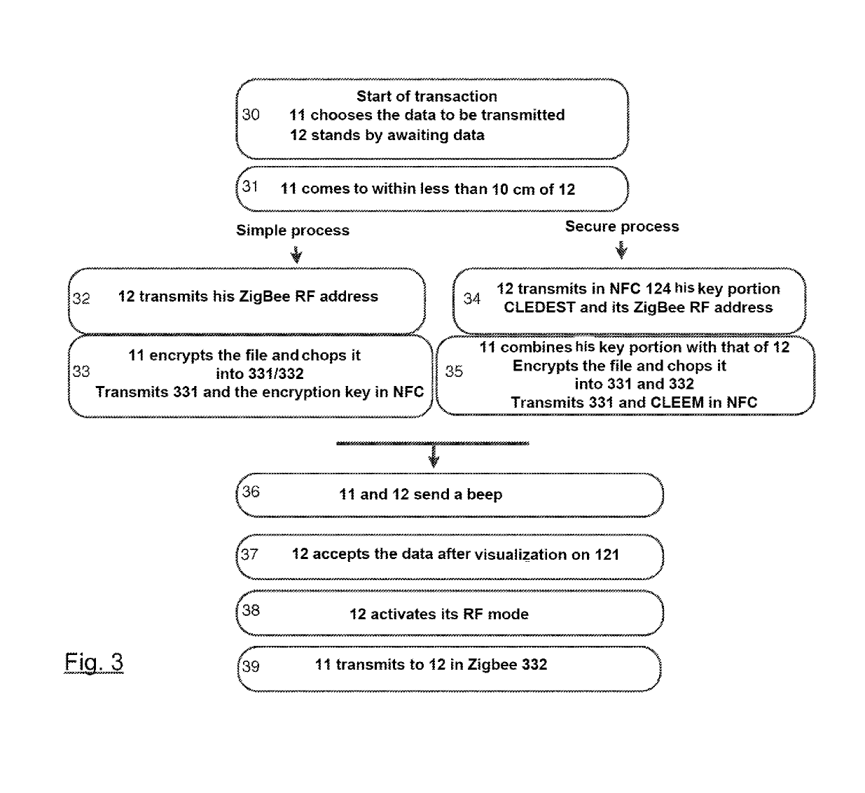

FIG. 3 diagrammatically shows an information transmission mode according to an embodiment of the invention, for example from terminal 11 to terminal 12.

In a simplified embodiment, the file can simply be divided and sent in two portions. This approach can be chosen, for example, if confidentiality is not required. If security requires it, an encryption is implemented, based at least on encryption information, according to a suitable encryption technique. This encryption can in particular take into account two keys or key portions, one provided by the sender terminal 11 (CLEEM) and the other provided by the recipient terminal 12 (CLEDEST). In this case, the method therefore comprises a step 34 of receiving the encryption key or key portion from the recipient CLEDEST, sent by NFC communication means.

This step may be optional, and is implemented only when a single encryption key is sufficient.

The terminal then encrypts the data to be sent according to the necessary encryption key(s), so as to deliver an encrypted file. In some cases, the encrypted file can also be stored in this form, so as not to repeat the encryption operations on each transmission.

The encrypted file is then divided 35 (or 33) into two file portions 331 and 332.

It is therefore necessary, in order to restore, upon receipt of the data, to have decryption means and to combine the two file portions.

A first encrypted file portion 331 must be sent in a first data set, by NFC communication 113. The data set comprises the first file portion, and, as the case may be, the key or key portion, provided by the sender terminal 11 (CLEEM) as well as identification data (ID), enabling the recipient terminal to identify the sender and, as the case may be, the information to be sent, so as to accept or reject the next transmission part.

The first data set can also include, according to the case and the applications, additional information, such as a timestamp, information on the size of the file to be sent, cost data, if the file is for a fee, and so on.

This identification data enables the recipient to accept or reject the next transmission part. If the sender terminal receives (38) acceptance information, it activates the radiofrequency transmission 39 of the second encrypted file portion 332.

As indicated above, this transmission is performed, for example, in ZigBee® format, which enables exchanges over relatively long distances.

It is consequently understood that, preferably, the largest part of the encrypted information is found in the second file portion, which is capable of being sent at a much higher rate. The first encrypted file portion may not be large, and thus be sent quickly in NFC. It is, however, preferably chosen so as to prevent even partial decoding of the second file portion, or to make it very complex.

An encryption technique capable of being used is the so-called AES (Advanced Encryption System) technique, proposed by the NIST (National Institute of Standards and Technologies) on the basis of the Rijndael algorithm.

This algorithm is advantageously implemented, in the context of an embodiment of the invention, with a random or pseudo-random constitution of the key of 50% on each side (by each terminal). The transmission of keys is advantageously itself encrypted, by means of a master key stored in a security component provided in each card.

Thus, in a particular embodiment, when two individuals want to exchange their cards, 11 and 12 respectively encrypt two key portions, a and b, by means of the AES algorithm, before exchanging them. These key portions are combined (35), undergo the same operation on each side, and deliver a common key AES for single use. The identity portion (ID) of the data is then encrypted and sent in NFC. A sound signal (a beep, for example) is emitted, signaling the receipt of the first portion.

It is possible to stack a plurality of exchanges in this NFC exchange phase (i.e. to initiate a connection with a plurality of participants, by quick contacts). Then, the end of the file(s), i.e. the second portion(s), is sent for example in ZigBee (in the form of encrypted raw data, without identity) to the various recipients.

Thus, even if a third party intercepts a second file portion, transmitted by radiofrequency, and manages to decrypt it, it will not have the useful information for integrally restoring the original file.

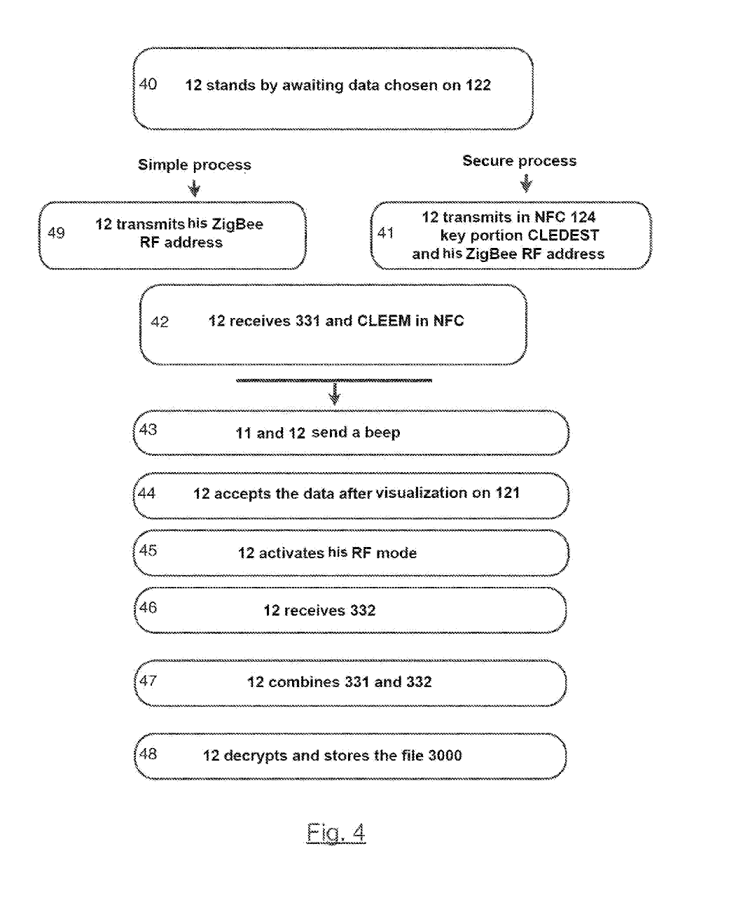

FIG. 4 shows the corresponding processing performed in the terminal 12 receiving the information.

If the key or key portion of the recipient is necessary (in order to implement step 34 of FIG. 3), the data exchange then begins by a transmission 41 of this key or key portion of the recipient, the RF address thereof (ZigBee) and optionally the identifier of the carrier, by NFC.

The sender terminal constructs (35) an encryption key, according to the first encryption key portion CLEDEST and a second encryption key portion CLEEM (provided by the sender terminal).

Then the terminal encrypts the file by means of the encryption key previously obtained, and then chops the encrypted file into two file portions 331 and 332.

According to another embodiment (not shown), the dividing step can be performed before the encryption. In this case, the two file portions resulting from the division can be encrypted independently. It is also possible, as the case may be, to encrypt only one of the two file portions. In addition, the mode of construction and exchange of keys or key portions can be adapted according to situations and requirements.

The sender terminal according to an optional embodiment (not shown) can implement a step of evaluating the size of said data file with respect to a predetermined parameter. Thus, according to this evaluation and the comparison of the file size with a predetermined parameter, for example, if the file size exceeds 100 Ko, the step of dividing said file into a first file portion and a second file portion is implemented if the file is large with respect to the predetermined parameter.

In addition, said first and second file portions can in particular correspond respectively to a header or a header portion and at least some content of said file.

The header comprises different data needed to interpret and/or process the content. Thus, without the header, it is impossible to recover the contents of the file (even if it has been successfully decrypted).

According to another approach, the coding can include the extraction inside the content, before and/or during encryption, of bits or bit sets (bytes, for example) and the insertion of these extracted bits into the data sent by NFC.

In this case, either the extracted bits are in predefined locations in the original file (beginning, middle, all of the x bits (x being a predetermined number), end, etc.) and the terminal therefore knows these locations a priori, or they are extracted randomly. In the latter case, the data sent by NFC also comprises the indication of the location of extracted bits in the content.

The choice of extracted bits can also take into account the size of the bits (heavy bits, or reference bytes, necessary for interpreting the next bytes by differentials, for example).

The recipient terminal 12 then receives (42), still in NFC, the first data set, comprising the first encrypted file portion 331, the identification data ID and the CLEEM (key or key portion provided by the sender terminal 11) 44. The user of the terminal 12 consults the identification information, for example, on the screen 121 and decides either to reject or to accept the next transmission part.

In the event of a rejection, the processing is interrupted. It is also possible for rejection information to be sent to the terminal 11 in RF.

In the event of an acceptance 43, acceptance information is sent to the terminal 11 by initializing the ZigBee point-to-point communication, and the latter sends the second data set, by RF communication, comprising at least the second encrypted file portion 332. This transmission is performed by radiofrequency communication means. The terminal therefore receives (46), by radiofrequency, this second data set and in particular the second encrypted file portion.

The two encrypted file portions received 331 and 332 are then combined (47) to restore a complete encrypted file. According to the key of the sender (CLEEM) sent in the first data set, and, as the case may be, the key of the recipient (CLEEDEST), the file is decrypted (48). The terminal 12 then has the file 3000, and can use it and store it as needed.

According to another embodiment (not shown), the step of combining file portions can be performed after decryption. In this case, the two file portions can be decrypted independently. It is also possible, as the case may be, to decrypt only one of the two file portions.

Other embodiments, options and alternatives can of course be envisaged, according to the uses and the data to be sent.

An exemplary embodiment of the invention provides a data exchange technique based on NFC communications, but also enabling relatively large amounts of data to be transferred within reasonable time periods.

An embodiment provides such a technique not requiring the users to continuously keep their respective terminals several centimeters away from one another.

An embodiment provides such a technique that ensures effective confidentiality of the data exchanged.

An embodiment provides such a technique that can be implemented in smaller and less expensive dedicated terminals.

An embodiment provides such a technique enabling the uniqueness of a sent document or information to be guaranteed in a simple and effective manner.

An embodiment provides such a technique enabling the electrical consumption of the terminals to be reduced.

Although the present disclosure has been described with reference to one or more examples, workers skilled in the art will recognize that changes may be made in form and detail without departing from the scope of the disclosure and/or the appended claims.

1. A method for secure transmission of a data file from a sender terminal to at least one recipient terminal, each comprising a near-field communication device, and implementing an encryption of said file, according to at least one encryption information item known or determined by said sender terminal,
wherein the method comprises the following steps, in said sender terminal:
receiving a first encryption key portion sent by said recipient terminal;
creating an encryption key, according to said first encryption key portion and a second encryption key portion, provided by said sender terminal;
encrypting said data file by the sender terminal, by said encryption key, delivering an encrypted file;
dividing said encrypted file into a first file portion and a second file portion;
sending, by said near-field communication device, a first data set comprising at least some of said encryption information and said first file portion to said at least one recipient terminal;
sending, by a radiofrequency transmitter, a second data set comprising at least said second file portion, to said at least one recipient terminal.

2. (canceled)

3. The method according to claim 1 wherein at least one of said first encryption key portion or said second encryption key portion are key portions for a single use, generated pseudo-randomly by the respective terminals.

4. method according to claim 1, wherein said dividing step implements a step of evaluating the size of said data file with respect to a predetermined parameter, and said step of dividing of said file into a first file portion and a second file portion is implemented if the file is larger than the predetermined parameter.

5. The method according to claim 1, wherein said first and second file portions correspond, respectively, to a header or a header portion and at least one content portion of said file.

6. The method according to claim 1, wherein said first data set also comprises data for identification of at least one of said sender terminal or a holder thereof.

7. The method according to claim 1, wherein the method comprises a step of receiving acceptance information by at least one of said recipient terminal, and said step of transmission by said radiofrequency transmitter provides no transmission if no acceptance information is received.

8. The method according to claim 1, wherein said radiofrequency transmitter is configured to implement a ZigBee® protocol.

9. A method for secure receiving, in a recipient terminal, of a data file sent by a sender terminal in which said terminals each comprise a near-field communication device, wherein the method comprises the following steps, in said recipient terminal:
receiving, by said near-field communication device, a first data set comprising at least some encryption information and at least one first file portion of said data file;
receiving a second file portion of said data file, by a radiofrequency communication receiver;
restoring the data file received, by combining said first and second file portions;
decrypting said data file received.

10. The method according to claim 9, wherein the method comprises the following steps:
sending a first encryption key portion to said sender terminal, so as to enable the sender terminal to construct an encryption key, by producing a second encryption key portion;
creating an encryption key, according to said first encryption key portion and a second encryption key portion, extracted from said first file portion.

11. The method according to claim 9, wherein said first data set also comprises data for identification of at least one of said sender terminal or a holder thereof, and the method comprises a step of accepting transmission from said sender terminal according to said identification data, resulting in transmission of acceptance information to said sender terminal, authorizing transmission of said second data set.

12. A sender terminal enabling secure transmission of a data file to at least one recipient terminal, comprising:
means for receiving a first encryption key portion sent by said recipient terminal;
means for creating an encryption key, according to said first encryption key portion and a second encryption key portion, provided by said sender terminal;
means for encrypting said data file by the sender terminal, by said encryption key, delivering an encrypted file;
means for dividing said encrypted file into a first file portion and a second file portion;
means for near-field transmission of a first data set comprising at least some of said encryption information and said first file portion to said at least one recipient terminal;
means for radiofrequency transmission of a second data set comprising at least said second file portion to said at least one recipient terminal.

13. A terminal enabling secure receiving of a data file intended for at least one recipient terminal, wherein the terminal comprises:
means for receiving, implementing near-field communications, a first data set comprising at least some encryption information and at least a first file portion of said data file;
means for receiving a second file portion of said data file, implementing radiofrequency communications;
means for restoring said data file received, by combining said first and second file portions;
means for decrypting said data file received according to at least one encryption information item known or determined by said sender terminal.

14. The terminal according to claim 12, wherein the terminal is in the form of a portable card equipped with a screen, enabling in particular identification data of at least one of another terminal or a user thereof to be displayed on said screen.

15. The terminal according to claim 13, wherein the terminal is in the form of a portable card equipped with a screen, enabling in particular identification data of at least one of another terminal or a user thereof to be displayed on said screen.
